(19) United States
(12) Patent Application Publication
(10) Pub. No.: US 2009/0191929 A1
(43) Pub. Date: Jul. 30, 2009

(54) GOLF SIMULATOR CONNECTED TO THE INTERNET

(75) Inventor: Daniel Antonio Nicora, Temecula, CA (US)

Correspondence Address: KNOBBE MARTENS OLSON & BEAR LLP, 2040 MAIN STREET, FOURTEENTH FLOOR, IRVINE, CA, 92614, US

(73) Assignee: Full Swing Golf, San Diego, CA (US)

(21) Appl. No.: 12/357,309

(22) Filed: Jan. 21, 2009

Related U.S. Application Data
(60) Provisional application No. 61/062,208, filed on Jan. 24, 2008.

(51) Int. Cl. A63F 13/00; A63F 9/24

(52) U.S. Cl. 463/3; 473/156

(57) ABSTRACT

A system for playing in a simulated indoor golf tournament comprises a web enabled physical golf simulator configured to transmit indoor golf performance data over a computer network during an indoor golf tournament. Tournaments can be conducted between players in different locations so that the participants in a given tournament need not be in the same city or country in order to compete. Players need not be available at the same time in order to compete against each other. In addition, the tournaments can be conducted live, with all participants competing at the same time, to simulate the pace of an outdoor golf tournament.

### CROSS-REFERENCE TO RELATED APPLICATIONS

The present application claims priority to U.S. Provisional Application No. 61/062,208, filed Jan. 24, 2008.

### BACKGROUND OF THE INVENTION

1. Field of the Invention

The present invention relates generally to computer based sports simulators, and more particularly to golf simulators. In particular, the invention relates to a golf simulator connected to the internet.

2. Description of the Related Art

Golf is a sport that is continuing to grow in popularity. One of golf's main attractions to enthusiasts is the continual challenge of improving one's game. To become an adept golfer and to maintain golfing proficiency, a significant amount of practice is required. However, few enthusiasts have the available time required to play full rounds of golf or to practice hitting golf balls at outdoor driving ranges. To solve this problem, many have found indoor golf simulators to be a viable alternative.

Golf simulators have been introduced for providing an indoor facility in which a golfer can practice all aspects of the golfing game. One example of such a device is disclosed in U.S. Pat. No. 5,333,874 to Arnold, et al., which is incorporated herein by reference. A second example of such a device is disclosed in U.S. application Ser. No. 11/837,289, which is also incorporated herein by reference.

Many golfers have found using golf simulators to be an efficient alternative to developing their golfing skills on golf courses; however, the use of such simulators as entertainment devices has not been explored, and advances in the art would be desirable.

### SUMMARY OF THE INVENTION

A method for conducting a virtual golf tournament comprising, receiving first data from a first physical golf simulator, receiving second data from a second physical golf simulator, calculating, based at least in part on the first data and the second data, information related to golf performance and/or relative ranking of a golf participant, and making the information available to remote users via a computer network.

A method of participating in a simulated golf tournament comprising, transmitting indoor golf scoring information from a physical golf simulator to a server over a network and, receiving said indoor golf scoring information from a server over a network on a user computer.

A method of viewing results of a simulated golf tournament comprising, receiving indoor golf statistical and/or player ranking information via a computer network and, displaying said indoor golf statistical and/or player ranking information on a user computer.

A system for playing in a simulated indoor golf tournament comprising, a web enabled physical golf simulator configured to transmit indoor golf performance data over a computer network during an indoor golf tournament.

### BRIEF DESCRIPTION OF THE DRAWINGS

FIG. 1 shows a golf tournament system.

FIG. 2 shows a set of steps to conduct a tournament.

FIG. 3 shows a view of a golf tournament interface.

FIG. 4 shows a second view of a golf tournament interface.

FIG. 5 shows a third view of a golf tournament interface.

FIG. 6 shows a fourth view of a golf tournament interface.

FIG. 7 shows a fifth view of a golf tournament interface.

FIG. 8 shows a golf simulator.

### DETAILED DESCRIPTION OF THE PREFERRED EMBODIMENT

Some embodiments augment golf simulators with the competitive and social aspects of the original game. In some embodiments of the present invention, golf simulators are connected on a network and users are allowed the opportunity to play competitively against one another in tournaments.

In some embodiments of the present invention, tournaments can be conducted between players in different locations so that the participants in a given tournament need not be in the same city or country in order to compete.

In some embodiments, players need not be available at the same time in order to compete against each other. In some other embodiments, the tournaments can be conducted live, with all participants competing at the same time, to simulate the pace of an outdoor golf tournament.

Other aspects and advantages of the present invention will become apparent from the following detailed description, which, when taken in conjunction with the accompanying drawings, illustrates by way of example the principles of the invention.

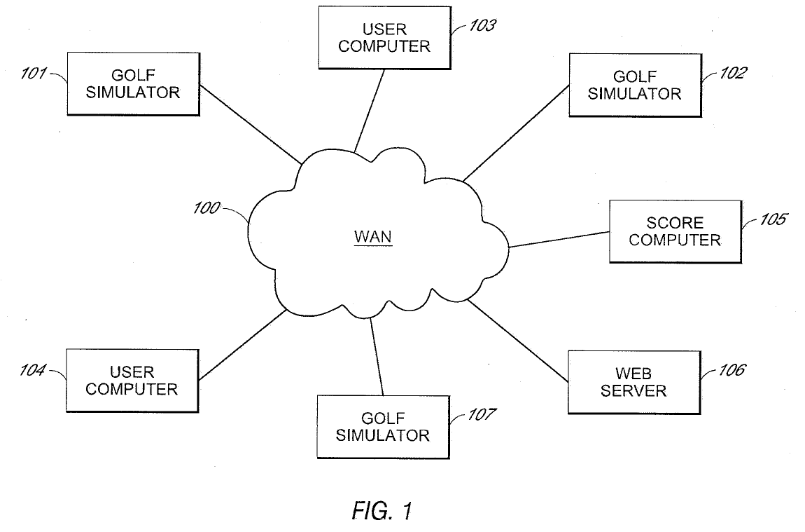

Aspects of the invention will now be described with reference to the Figures. Referring first to FIG. 1, a simulator network is shown. Common characteristics of a simulator network include a Wide Area Network (“WAN”) 100, multiple golf simulators 101, 102, multiple user computers 103, 104, a scoring computer 105, and a web server 106. The scoring computer and web server may comprise the same computer system, and it will further be appreciated that the functionality of the devices of FIG. 1 can be placed wholly or partly in any or all of the devices illustrated in FIG. 1.

The golf simulators 101, 102 may comprise devices according to the Arnold patent and U.S. patent application Ser. No. 11/837,289, incorporated above. The golf simulators 101, 102, the user computers 103, 104, the scoring computer 105, and the web server 106 are connected to a WAN 100 by computer network protocols and devices that are well-known in the art. The WAN 100 is a computer network, e.g. the internet. In some embodiments of the invention, the WAN 100 is a Local Area Network (“LAN”). In some embodiments, the WAN is a company intranet. In some embodiments the user computers 103, 104 comprise computer terminals configured to provide a web browser to a user. In some embodiments the user computers 103, 104 are configured to provide computer applications that interact with any of the golf simulators 101, 102, the scoring computer 105, and the web server 106, to display data related to players' use of the golf simulators 101, 102.

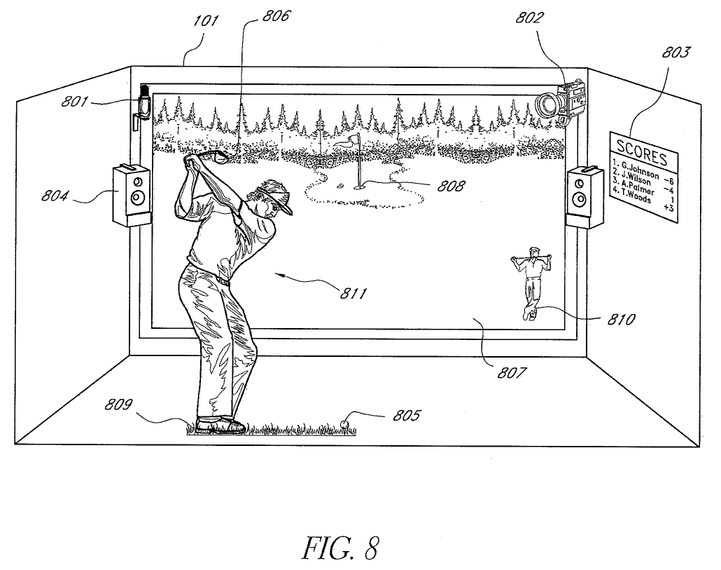

FIG. 8 depicts an embodiment of the golf simulator 101 illustrated in FIG. 1. The golf simulator 101 physically simulates the game of golf in the sense that use of the golf simulator 101 requires actually striking a golf ball 805 with a golf club 806. Typically, such golf simulators 101 will have a large display screen 807 that has an image of the golf hole 808 being played from the vantage point of the user's position 809. The golf ball 805 will strike the screen 807 after being hit by the club 806, and a variety of sensors will compute a golf ball trajectory based on the golf ball position, velocity, rotation, etc. The trajectory will then be displayed on the screen 807 as if the ball 805 were physically moving through the golf course. While a user 811 is in the simulator, in some embodiments the user's likeness may be captured by a video camera 802 and/or a microphone 801, as described below. This likeness information may be transmitted to another golf simulator 102 to be displayed to a remote user. In the same way, the golf simulator 101 may receive likeness information 810 from a remote golf simulator 102 and incorporate that likeness information into the displayed image in the screen 807. In this way, the user 811 of the golf simulator 101 may be presented with an image and/or audio signals of another golfer 810 who is playing on the same course as the user 811.

The embodiments described herein are vastly different from computer or video golf games where a computer keyboard or game controller is used to input shot parameters and virtually strike a virtual golf ball. Although such computer games may provide entertainment for limited period of time until a person has reached a particular level of proficiency, interest in the game quickly wanes. In contrast, because a physical golf simulator requires striking a physical golf ball with a physical club, the game cannot be mastered for the same reasons outdoor golf cannot be mastered. Room for improvement and the drive to improve always exists. This continual drive to improve can be harnessed with the system of FIG. 1 in a way not previously appreciated or implemented.

Tying indoor physical golf simulators as described above into a communication network with a scoring system and web server as shown in FIG. 1 allows a wide variety of exciting opportunities for indoor golf players. For example, indoor golf tournaments can be held, where the players can be located anywhere in the world that a golf simulator connected to the system is located. As will be described further below, approximately real-time updates to golf scores of the tournament players as holes are played can be computed by the scoring computer and made available in approximately real time to tournament participants and spectators alike via the web server. Because scoring data on the different players is received and may be retained and processed by the scoring computer, player handicaps and other individual statistics can be computed just as in outdoor golf. Such information can be quite detailed, such as average shot distance with a particular club.

More complex competitive organization is also possible. For example, a series of multiple tournaments can be created where players' performance over the course several tournaments can be used to rank players on an indoor golf tour. Yearly or lifetime “winnings” can be computed, tracked, and publicized. Player profiles can be created and made available via the web server to promote an indoor golf fan base for skilled indoor golf competitors. Essentially every competitive aspect of outdoor golf can he reproduced with indoor golf, dramatically increasing the usefulness and player enjoyment of indoor golf simulators. In fact, the present inventions allow and facilitate the creation of the new professional sport of indoor golf, where skilled players can earn a living winning prize money from tournaments or tours that may be sponsored or that may require an entry fee to play.

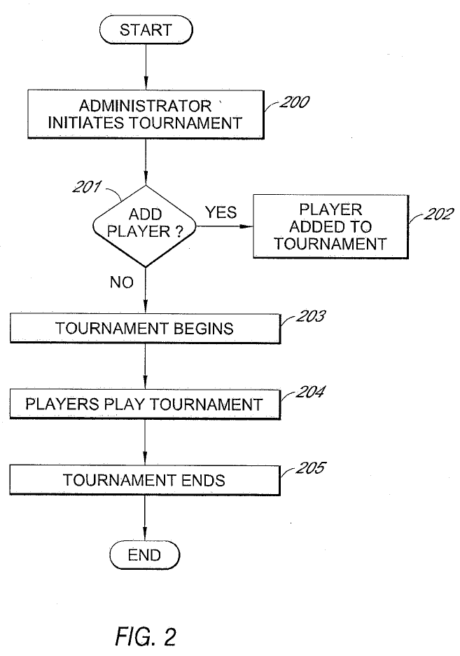

Referring now to FIG. 2, a flow chart depicting some of the mechanics of the progression of an indoor golf tournament is shown. In some embodiments of the present invention, an administrator initiates a tournament 200. In some embodiments, the administrator is the owner of the golf simulator or an agent thereof. In some embodiments, the administrator can be any user of the golf simulator. In some embodiments, the tournament can be initiated from any of the golf simulators 101, 102, the user computers 103, 104, the scoring computer 105, and/or the web server 106 simulator; however, in some other embodiments, the tournament may only be initiated from a subset of those devices.

In some cases, various indoor golf facilities are located in various places around the country or world, just as there are real outdoor golf courses located in various places around the country and world. Typically, each facility will have several golf simulators. In a simple competition, two players on two different simulators at the same facility can initiate their own two player tournament and compete against each other while playing at the same time. Because the simulators are connected over the network, an updated display of both scores can be provided on the screen, so each can see the other's progress and score as they play. Alternatively, patrons of a particular facility can create a tournament that takes place over a week, month, or other defined period in which they alone are the participants, and the player scores and current results of the tournament can be updated and made available to anyone via the web server. In another tournament format, two different facilities could create a tournament where patrons of the two facilities compete against each other on a team basis. A variety of tournament styles limited to specific facilities, countries, or unlimited open tournaments in which anyone can play can be created by the operator of the scoring system/web server. Prizes could be awarded in a variety of ways.

During the initiation of the tournament, the administrator will choose settings for the tournament. Such settings may include whether the tournament is invitation only; the identities of the invitees, if any; inclusion and/or exclusion criteria (e.g. minimum and/or maximum handicap) for players attempting to join the tournament; the number of players allowed in the tournament; the course or courses to be played in the tournament; the number of holes to be played in the tournament; the rules of the tournament; the format of the tournament; any time restrictions on the tournament; the weather and climate settings for the tournament; and many other settings related to the golf tournament.

After a tournament is initiated 200 or, in some embodiments, during the initiation of the tournament 200, an administrator or a user may add players to the tournament 201 until no more players are left to be added. While a player is left to be added to the tournament, the relevant interface (e.g. a golf simulator, 101, 102, or a user computer 103, 104) may prompt the administrator or user to enter information sufficient to add a player to the tournament 202. Once all of the players are added to the tournament, the tournament begins 203.

Once a tournament has begun 203, players will begin to play in the tournament 204. The order and manner of playing will be determined based on the rules and format of the game as determined during the initiation of the tournament 200, and other information that may be provided by the administrator at any time.

Because it is indoor golf, tournament play can be temporally and geographically widespread. Of course, different tournament players can play at different times and at different locations, but in addition an individual player may, for instance, begin a tournament and play the beginning of a tournament in one location, and then finish the same tournament in another location, on a different golf simulator 101, 102.

During a tournament 204, a plurality of users can play from the same golf simulator 101, 102, or from different golf simulators 101, 102. In some embodiments, as each user completes a hole, data about the score for the hole is uploaded from the golf simulators 101, 102 to the scoring computer 105. The scoring computer 105 is configured to interpret the data received in order to score and record information about the tournament and to rate and record information about the players. As the tournament progresses, the golf simulators 101, 102 may receive information from the scoring computer 105 relevant to the ranking and scores of the various players involved in the tournament. In some embodiments, the golf simulators 101, 102 are configured to display information about the tournament to the users of the golf simulators 101, 102. In these embodiments, the screen of the golf simulators 101, 102, or another display on the golf simulator can display a leader board with current scores, ranking information, as well as any other information that is available to users via the user computers 103, 104. The information displayed on the golf simulator can be configured by an administrator or another person, depending on the rules and format of the tournament, and other relevant considerations.

In addition, the user computers 103, 104 can access scoring, ranking, and statistical information about ongoing and completed tournaments stored on the scoring computer 105, and/or the web server 106.

In some embodiments, some or all of the golf simulators 101, 102 may be equipped with microphones, video cameras, still cameras, or other suitable devices to capture the audio-visual information (e.g. visual likeness information and audio likeness information) of one ore more users of these golf simulators 101, 102. When such information is available, some or all of the golf simulators 101, 102, may be configured so that the screen of the golf simulators 101, 102, or another display on the golf simulator can present the information including still pictures, video pictures, and/or topographical pictures of one user of a golf simulator to another user or users of golf simulator(s) 101, 102. Additionally, speakers in the golf simulators 101, 102, may be configured to present audio information including captured speech or utterances to a user. In this way, a user of a golf simulator 101, 102, may be presented with a representation of a different user to simulate playing a game of golf with another person. In some embodiments, the video information can be incorporated into the game so that each player sees each other player in the virtual golf course. Similarly, in some embodiments, auditory information may be incorporated into the game so that each player hears the voice and sounds from other players. These features add numerous benefits, as can be appreciated by a person of ordinary skill in the art. For instance, in some embodiments in which visual information is transmitted among golf simulators 101, 102, in real time or approximately real time, players can watch each other swing, and watch the motion of each other's shots. Players can communicate with other players, for instance players can communicate congratulatory statements, statements of frustration, comments as to strategy (e.g., which club to use), trash-talk comments, or any other sound that could normally be communicated among players at a traditional golf course.

In some embodiments, the audio-visual information can be stored, so that players playing at different times can see and/or hear that likeness information after the player creating the information is no longer using the golf simulator 101, 102.

In some embodiments, the audio-visual information can be made available on user computers 103, 104, the scoring computer 105, or on the web server 106. For instance, users at home can look at recorded information to watch the performance of a player in a previous round. In some embodiments, the user may use the user's own likeness to display on the web server 106 or elsewhere, or to analyze the user's own performance.

In some embodiments, the audio-visual information is sufficient to allow an instructor, watching a user's likeness on a golf simulator 101, 102, on a scoring computer 105, or on the web server 106, to critique the user's performance, and give lessons or tips either live through the golf simulator 101, 102, live over some other communication medium, or later, after the user has stopped using the golf simulator.

Once a tournament concludes 205, the golf simulators 101, 102, and/or the user computers 103, 104 may present information regarding the completed tournament. The scoring computers, can update the players with the results of the tournament and other statistical information about the tournament. The players' handicaps win counts, win ratios, and other relevant information can be adjusted to reflect the results of the tournament. Such information is optionally available through the user computers 103, 104, the golf simulators 101, 102, the web server 106, and/or the scoring computer 105.

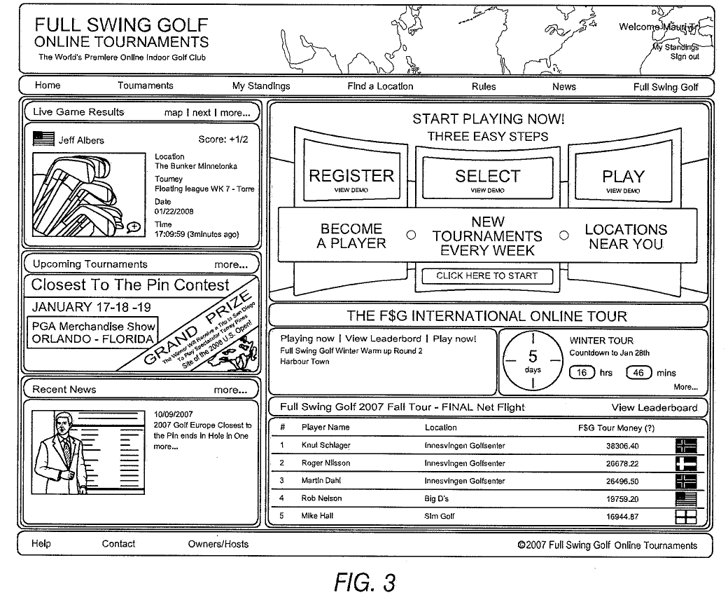

Referring now to FIG. 3, a webpage as viewed on a user computer 103, 104 and served by a web server, 106 is shown. The webpage of FIG. 3 comprises a user interface whereby users of golf simulators 101, 102 can register indoor golf players, enter tournaments, find geographical locations of golf simulators 101, 102, view statistics and scores relating to players, and view approximately real time information regarding scores and standings for tournaments in progress.

For example, in FIG. 3, a player by the name of “Jeff Albers” is shown. Jeff Albers is shown to have a Score of +½, meaning that his score in the round is one over par after two holes played. The user playing as Jeff Albers was playing at “The Bunker” in Minnesota at the time this screen capture was taken. At the time of this screen capture, Jeff Albers was playing in a tournament identified as “Floating League Wk 7—Torre.”

This demonstrates of the scoring computer's ability to compile the scores of players playing in golf simulators 101, 102 in approximately real-time, and to present tournament and other scoring information to users of the user computers 103, 104 via the web server 106 as live updates. This real-time aspect of some embodiments of the invention allows for a richer user experience, as users of user computers at home 103, 104, user computers 103, 104 at facilities containing golf simulators, and users of golf simulators 101, 102 can have immediate updates of the scores of other players, so as to enhance the social and competitive aspects of the game.

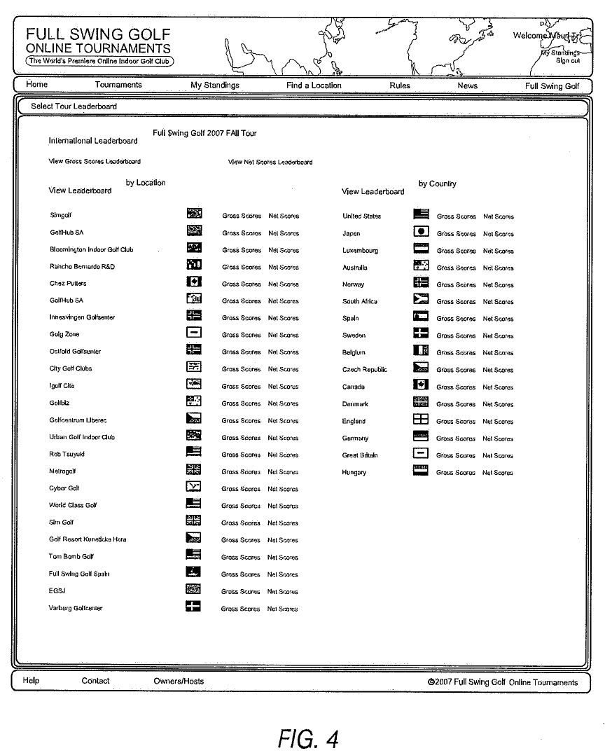

Referring now to FIG. 4, another webpage as viewed on a user computer 103, 104 and served by a web server 106, is shown. The webpage of FIG. 4 comprises a leaderboard for a tour played on golf simulators. The list of leaderboards shown in FIG. 4 is accessible from the webpage shown in FIG. 3 by selecting the “View Leaderboard” hyperlink visible in FIG. 3. The list of leaderboards in FIG. 4 presents accessible leaderboards by Location on the left side of the screen and by Country on the right side of the screen. A user may select any location or country to see the scores of all of the players involved who have been playing at the selected location.

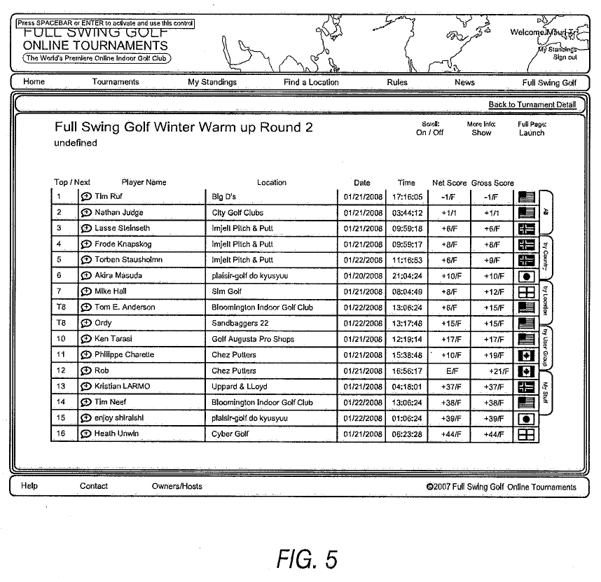

Referring now to FIG. 5, a webpage as viewed on a user computer 103, 104 and served by a web server 106, is shown. The webpage of FIG. 5 comprises a leaderboard for a golf tournament. This leaderboard, which would be updated live in normal use, displays the up-to-date scores and other details about users involved in a tournament. The Player Name, Location, Date, Time, Net Score, and Gross Score are accessible for each player in the tournament The list may be filtered by buttons on the right to show all players, only players of a user-selected country, only players in a user-selected location, or only players in a user-selected user group.

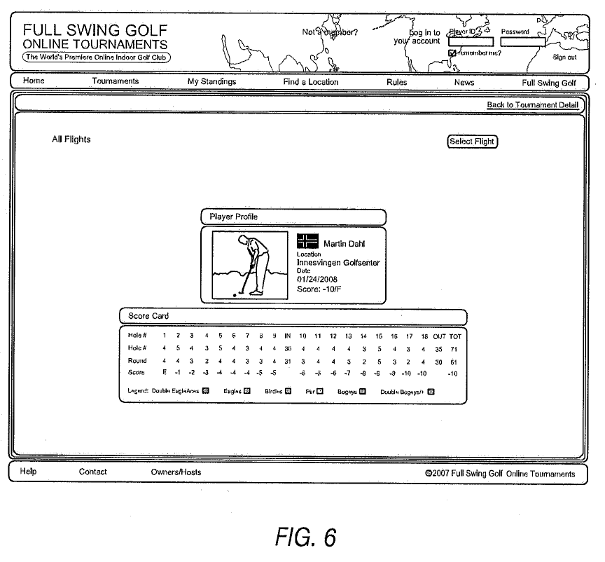

Referring now to FIG. 6, a webpage as viewed on a user computer 103, 104 and served by a web server 106, is shown. The webpage of FIG. 6 comprises the leaderboard of FIG. 5, wherein the user has selected the speech-bubble symbol to the left of the player name: “Martin Dahl.” In this view, the user can see more information about the player Martin Dahl, including a score card listing the player's score versus par for each hole played in the tournament. This data is also updated live, and available for users including teammates, opponents, and fans of the player to watch the player's progress over time.

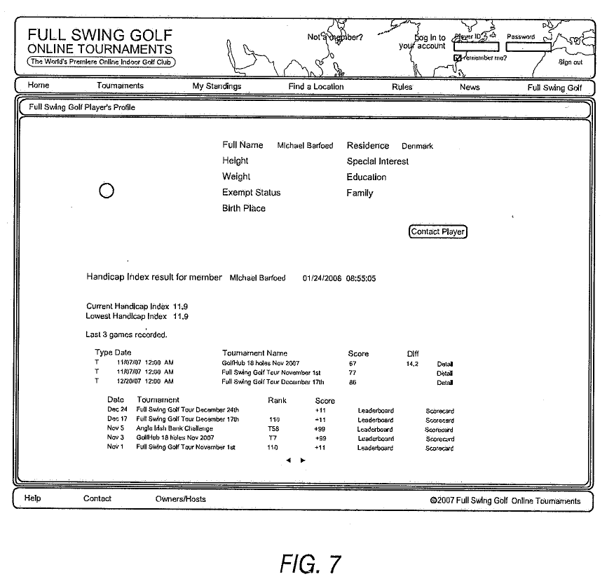

Referring now to FIG. 7, a webpage as viewed on a user computer 103, 104 and served by a web server 106, is shown. The webpage of FIG. 7 comprises statistics for a single player, “Michael Barfoed.” This view is accessible by selecting the hyperlink associated with a player name from the home page (FIG. 3) or from any leaderboard on which the player's name appears (e.g. FIG. 6). From this view, a user may learn details about a given player, including the player's past performance in tournaments and other play, the player's country of residence, and other biographical information the player's user provides. From this view, a user may also see the player's handicap.

The skill involved in playing a golf simulator translates to playing traditional golf outside and a player's skill in a golf simulator is highly correlated with a player's skill in actual games of golf. Because of this, some golf courses that require golfers to have established handicaps before they are allowed to play the courses may start to accept handicaps from golf simulators as evidence of the player's skill in the traditional game of golf. A player wishing to play golf at such a golf course could use the Player Profile display of FIG. 7 to verify the player's golf simulator handicap and thereby gain access to the course.

Other embodiments of the invention will be apparent to those skilled in the art from a consideration of this specification or practice of the invention disclosed herein.

What is claimed is:

1. A method for conducting a virtual golf tournament comprising:
receiving first data from a first physical golf simulator;
receiving second data from a second physical golf simulator;
calculating, based at least in part on the first data and the second data, information related to golf performance and/or relative ranking of a golf participant; and
making the information available to remote users via a computer network.

2. The method of claim 1, wherein the information comprises a handicap.

3. The method of claim 1, wherein the first data comprises a number of player profiles.

4. The method of claim 1, wherein the first data comprises information about the physical movement of a golf ball.

5. The method of claim 1, wherein the first physical golf simulator and the second physical golf simulator are in different cities.

6. The method of claim 1, further comprising receiving audio and/or visual information from a first physical golf simulator, and transmitting the likeness information to a second physical golf simulator.

7. The method of claim 6, further comprising making the audio and/or visual information available to remote users via a computer network.

8. A method of participating in a simulated golf tournament comprising:
transmitting indoor golf scoring information from a physical golf simulator to a server over a network and;
receiving said indoor golf scoring information from a server over a network on a user computer.

9. The method of claim 8, further comprising transmitting audio and/or visual information from a physical golf simulator over a network.

10. The method of claim 9, further comprising receiving visual information from a physical golf simulator over a network, and displaying the visual information on a display in the physical golf simulator.

11. A method of viewing results of a simulated golf tournament comprising:
receiving indoor golf statistical and/or player ranking information via a computer network and;
displaying said indoor golf statistical and/or player ranking information on a user computer.

12. The method of claim 11, further comprising receiving audio and/or visual information of a player and displaying the likeness information on a computer display.

13. A system for playing in a simulated indoor golf tournament comprising:
a web enabled physical golf simulator configured to transmit indoor golf performance data over a computer network during an indoor golf tournament.

14. The system of claim 13, wherein the physical golf simulator further comprises a display configured to display golf performance data from other web enabled physical golf simulators during an indoor golf tournament.

15. The system of claim 14 further comprising a video camera and/or a microphone configured to capture likeness information of a player in the web enabled physical golf simulator.

16. The system of claim 15, further configured to transmit the likeness information over a computer network during an indoor golf tournament.
